(19) United States
(12) Patent Application Publication
(10) Pub. No.: US 2026/0084750 A1
(43) Pub. Date: Mar. 26, 2026

(54) COMPUTER-IMPLEMENTED METHOD FOR CONTROLLING A DRIVER ASSISTANCE SYSTEM, DRIVER ASSISTANCE SYSTEM, COMPUTER PROGRAM PRODUCT, USE OF THE DRIVER ASSISTANCE SYSTEM, VEHICLE

(71) Applicant: Robert Bosch GmbH, Stuttgart (DE)

(72) Inventors: Uwe-Philipp Kaeppeler, Gerlingen (DE); Andras Sarosi, Székesfehérvár (HU); Bjoern Herder, Stuttgart (DE); Christian Pampus, Leonberg (DE); Christoph Delfs, Bretten (DE); Marc Oliver Hoefling, Lonnig (DE); Marco Wochele, Ostelsheim (DE); Marco Hoch, Stuttgart (DE); Matthias Fuchs, Pleidelsheim (DE); Peter Rikk, Budapest (HU); Sebastian Olbrich, Weinsberg (DE); Tamas Mocsai, Budapest (HU); Tom Schubert, Brackenheim (DE); Vivek Mattar, Stuttgart (DE)

(21) Appl. No.: 19/323,574

(22) Filed: Sep. 9, 2025

(30) Foreign Application Priority Data
Sep. 26, 2024 (DE) 10 2024 209 318.1

(51) Int. Cl. B62D 15/02; B62D 6/00

(52) U.S. Cl. CPC B62D 15/0285; B62D 6/00

(57) ABSTRACT

A computer-implemented method for controlling a driver assistance system for a vehicle. The driver assistance system provides a stored parking or positioning maneuver along a stored trajectory. The method includes: receiving a radio signal for activating traversal of the stored trajectory, wherein the radio signal is received from a smartphone or another mobile electronic device; determining a new target position of the vehicle based on an ascertained current position of the user, the smartphone, or the device, wherein the new target position is determined by the point on the stored trajectory that is closest to the ascertained position of the user, the smartphone, or the mobile electronic device of the user; and controlling the vehicle to traverse the stored trajectory to the new target position.

### CROSS REFERENCE

The present application claims the benefit under 35 U.S.C. § 119 of Germany Patent Application No. DE 10 2024 209 318.1 filed on Sep. 26, 2024, which is expressly incorporated herein by reference in its entirety.

### FIELD

The present invention relates to a computer-implemented method for controlling a driver assistance system for a vehicle. The present invention further relates to the driver assistance system, which supports the driver in maneuvering, for example when the vehicle is pulling into and/or out of a parking space. The present invention also relates to a computer program product comprising program code means or instructions that are designed to carry out the method according to the present invention when the computer program product is run on a computing unit. Furthermore, the present invention relates to the use of the driver assistance system according to the present invention for controlling a vehicle, wherein the vehicle maneuvers along a stored trajectory and, upon activation from outside the vehicle, moves to a new target position that is close to the current position of a user or driver. Furthermore, the present invention relates to a vehicle comprising the driving assistance system according to the present invention.

### BACKGROUND INFORMATION

Various systems are described in the related art for assisting the driver with pulling into and out of parking spaces. For example, Europe Patent Application No. EP 2 882 632 A1 describes a method for carrying out a parking process of a vehicle by means of a driver assistance system. Europe Patent Application No. EP 2 746 139 A1 describes a device for remote operation of vehicles.

Europe Patent No. EP 3 158 548 B1 describes a valet parking system for automatically moving a vehicle to an assigned parking space.

Germany Patent Application No. DE 10 2021 214 840 A1 describes a method for maneuvering a vehicle out of a parking space.

Europe Patent No. EP 2 493 745 B1 describes a method for assisting a driver with pulling a vehicle out of a parking space.

U.S. Patent Application No. US 2024/114542 A1 describes a method and a system for localizing a mobile electronic device, for example a smartphone, by means of ultra wide band technology or an antenna-based localization method.

An object of the present invention is to improve a computer-implemented method for controlling a driver assistance system, in particular for automatically pulling out of a parking space.

### SUMMARY

The above object may be achieved according to certain features of the present invention.

The present invention relates to a computer-implemented method for controlling a driver assistance system for a vehicle, in particular for supporting parking and positioning maneuvers. According to an example embodiment of the present invention, the driver assistance system is designed to automatically control the vehicle according to a stored parking or positioning maneuver along a stored trajectory in the vehicle's surroundings. Preferably, the stored trajectory is created and saved by means of a learning run of the driver or user. This allows individual adaptation of the parking or positioning maneuver to the specific local needs and preferences of the driver or user, in particular in frequently visited or familiar surroundings (e.g., in the so-called home zone). The stored trajectory has, in particular, a start and end point. The driver assistance system is in particular designed to automatically control the vehicle forward and/or backward along the stored trajectory, wherein the steering and the propulsion are actuated or controlled. A key advantage of this system is that the driver can control the vehicle from outside, which significantly increases the flexibility and convenience of parking.

A method according to an example embodiment of the present invention comprises a plurality of steps. First, a radio signal is received to activate traversal of the stored trajectory by means of the driver assistance system. This radio signal is sent by a smartphone or another electronic device. The user, who is advantageously located outside the vehicle, initiates in particular the transmission of the radio signal for activation by an input from the user recorded by means of the smartphone or the electronic device. The advantage of this method is its ease of use, as the driver does not have to be in the vehicle to start the parking maneuver.

In the next step, a new target position or a new stopping position of the vehicle is determined based on the ascertained current position of the user, the smartphone or the electronic device. In other words, the new target position or the new stopping position advantageously does not correspond to the end position of the stored trajectory originally stored by a learning run. This new target position is determined by the point on the stored trajectory that is closest to the current position of the user, the smartphone or the electronic device of the user or driver.

The vehicle is then controlled, in particular the steering system and/or the drive system, to traverse the stored trajectory to the new target position. This results in a high level of comfort for the user, as he only has to travel a short distance from his current position to get into the vehicle, and it allows efficient control of the vehicle, as no unnecessary routes are taken by the vehicle, in particular since the new target position is dynamically adapted to the user's current position. In other words, the present invention ensures a high level of comfort for the user and a safe and precise execution of the parking or positioning maneuver.

According to a preferred example embodiment of the present invention, the received radio signal represents the current position of the smartphone or the electronic device of the user, which position is ascertained in particular by means of the smartphone or electronic device and a global navigation satellite system (GNSS). This offers the advantage of sufficiently high accuracy during position determination.

In a particularly preferred embodiment of the present invention, the current position of the user, the smartphone or the mobile electronic device of the user is determined alternatively or additionally by means of at least one sensor of the vehicle. This can be done by means of an antenna-based localization method and/or by object detection and distance determination using distance sensors and/or vehicle cameras. This method offers the advantage of robust and versatile position determination that works reliably even in environments with limited GNSS reception. In addition, the accuracy of the position determination of the user, the smartphone or the electronic device is increased.

In an optional embodiment of the method of the present invention, the new target position is additionally adjusted such that the shortest path between a predetermined or user-selected door of the vehicle and the position of the user, the smartphone or the device of the user results. This increases comfort for the user, as the vehicle is positioned with the shortest route to the specified or selected door at the user's location to facilitate entry or exit.

In one example embodiment of the present invention, when the function is activated by the driver, the stored trajectory with the new target position is displayed on a display device of the vehicle and/or sent to the smartphone and/or the device of the user for display. This offers the advantage of visual feedback and increases transparency and control for the user.

While traversing the trajectory, the vehicle advantageously detects and avoids obstacles that are recorded or detected by at least one sensor of the vehicle. This advantageously ensures a high level of safety and prevents collisions during parking or positioning maneuvers.

A driver assistance system for a vehicle according to an example embodiment of the present invention comprises a memory device for storing a trajectory for a parking or positioning maneuver, a communication device for receiving and/or transmitting radio signals, a computing unit for determining a new target position of the vehicle based on the current position of the user, the smartphone, or other electronic device of the user, and a control unit for controlling a steering system and/or a drive system of the vehicle. The driver assistance system according to the present invention is designed to carry out the method according to the present invention.

In a further development of the present invention, the driver assistance system additionally comprises a sensor system for radio location or a sensor system for an antenna-based localization method and/or at least one distance sensor, for example an ultrasonic sensor and/or a radar sensor, and/or a vehicle camera. These sensors allow precise and versatile position determination of the user and object detection of the user, the smartphone or the other mobile electronic device.

The computing unit of the driver assistance system can be designed to adjust the new target position such that the shortest path between a predetermined or user-selected door of the vehicle and the position of the user, the smartphone or the device of the user is provided. This further increases the comfort and user-friendliness of the driver assistance system. For this purpose, the position of the door can be stored in a memory. The user can advantageously select a door by means of an input recorded on the electronic device or smartphone.

The present invention also relates to a computer program product comprising program code means or instructions that are designed to carry out the method according to the present invention when the computer program product is run on a computing unit. This allows for simple implementation and widespread adoption of the method.

The present invention also relates to the use of the driver assistance system according to the present invention for controlling a vehicle, in particular a motor vehicle, wherein the vehicle maneuvers along a stored trajectory and, upon activation from outside the vehicle, moves to a new target position that is close to the current position of the driver. The use according to the present invention offers considerable advantages in terms of comfort and flexibility for the user.

Finally, the present invention also comprises a vehicle having a driver assistance system according to the present invention as described. This allows for the system to be fully integrated into modern vehicles, offering users advanced and convenient support when parking and maneuvering.

Further advantages arise from the following description of exemplary embodiments with respect to the figures.

### BRIEF DESCRIPTION OF THE DRAWINGS

FIG. 1 shows a flowchart of the method as a block diagram, according to an example embodiment of the present invention.

FIG. 2 shows schematic of the situation in carrying out the method, according to an example embodiment of the present invention.

### DETAILED DESCRIPTION OF EXAMPLE EMBODIMENTS

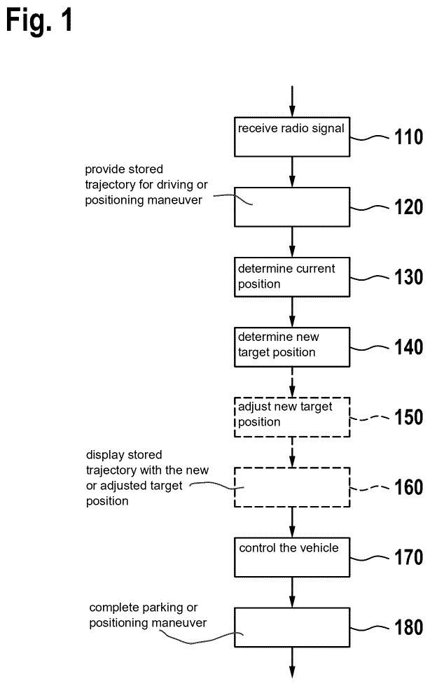

FIG. 1 shows a flowchart of the computer-implemented method for controlling a driver assistance system for a vehicle schematically as a block diagram. First, the driver assistance system is activated by a user who is outside the vehicle. This activation or initialization of the driver assistance system is carried out depending on the reception 110 of a radio signal from a smartphone or another electronic device. In other words, the radio signal received in step 110 represents a user input recorded by means of a smartphone or other electronic device to activate traversal of the stored trajectory. In the following step 120, the stored trajectory for the driving or positioning maneuver is provided, wherein the stored trajectory represents in particular a process of the vehicle pulling into and/or out of a parking space, in particular in an environment that is familiar to the user or one the user frequently visits. In a next step 130, the current position of the user, the smartphone or the other electronic device is determined. It can be provided that the received radio signal represents the position of the user or the smartphone or the other electronic device. For example, the radio signal represents a position determined by means of the smartphone and a global navigation satellite system (GNSS), such as GPS or GLONASS. In other words, the radio signal received in step 130 represents the position of the smartphone or the electronic device of the user, which position is ascertained by means of a global navigation satellite system (GNSS).

In other words, in step 130, the position of the user, the smartphone or the electronic device can be ascertained or recorded based on the radio signal. Alternatively, in step 130, the position of the user, the smartphone or the electronic device is additionally or alternatively ascertained based on a sensor system or at least one sensor of the vehicle. For example, the user is detected in a camera image and his position relative to the vehicle is ascertained. Alternatively or additionally, in step 130, the position of the user, the smartphone or the electronic device is determined by means of a sensor system of the vehicle for an antenna-based localization method or a distance determination by means of distance sensors of the vehicle. In step 140, a new target position of the vehicle is determined based on the position of the user, the smartphone or the device ascertained in step 130. The new target position is determined in step 140 by the point on the stored trajectory that is closest to the ascertained position of the user, the smartphone or the device of the user. In other words, in this step the new final position or target position on the stored trajectory is calculated by determining the shortest path or path perpendicular to the trajectory between the trajectory and the user's position. In an optional subsequent step 150, the ascertained new target position is adjusted depending on a predetermined or selected door of the vehicle. The adjustment 150 of the target position is carried out in particular depending on the shortest path between a predetermined or selected door of the vehicle and the position of the user. The predetermined door is provided by the vehicle, for example. Alternatively, a user input is recorded by means of the smartphone and/or the electronic device to select the door, wherein the radio signal in this case advantageously represents the door (to be approached). In optional step 160, after the user has activated the function, the stored trajectory with the new or adjusted target position is displayed on a display device of the vehicle and/or sent to the smartphone and/or the electronic device of the user for displaying the stored trajectory with the new or adjusted target position on the smartphone and/or the electronic device. In all cases, the display can be abstracted. In other words, in step 160, the stored trajectory with the new or adjusted target position can be displayed on a display device of the vehicle and/or sent to the smartphone of the user. In step 170, the vehicle, in particular the steering system of the vehicle and/or the drive system of the vehicle, is controlled to traverse the stored trajectory to the new or adjusted target position. In other words, in step 170, the steering system and/or drive system of the vehicle is controlled to traverse the stored trajectory to the new or adjusted target position. While driving along the stored trajectory, obstacles are advantageously detected by the sensors of the vehicle and avoided by adjusting the trajectory. In step 180, the parking or positioning maneuver is completed at the new or adjusted target position.

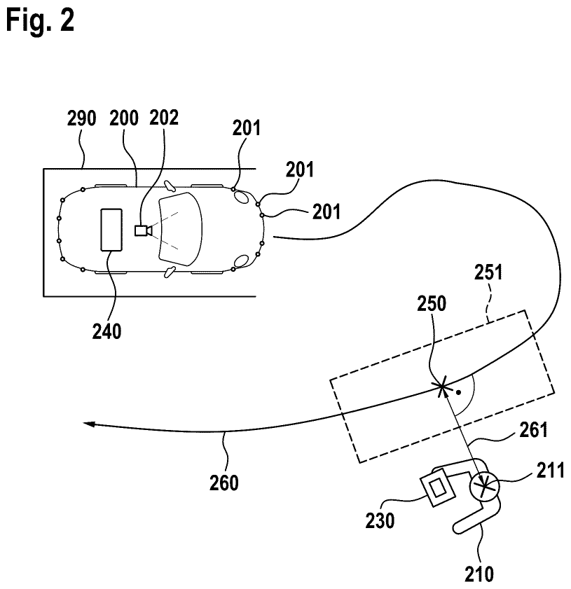

FIG. 2 schematically shows an example of a situation in carrying out the method viewed from above. A driver or user 210 is standing outside his vehicle 200 parked in a garage 290 and would like the vehicle 200 to automatically pull out of the parking space or drive toward him in order to be able to get in comfortably. The user 210 uses his smartphone 230 or another mobile electronic device, such as a radio key, to activate the driver assistance system. The driver input for activating the driver assistance system of the vehicle 200 is recorded by the smartphone or another mobile electronic device and sent to the vehicle 200 or the driver assistance system 240, for example, by a mobile radio signal and via a server device or alternatively, for example, by a WLAN signal or another radio signal. Subsequently, an automatic journey of the vehicle 200 along a previously stored trajectory 260 is controlled by the driver assistance system 240 to a new target position 250 on the stored trajectory 260 which is closest to the driver or user 210. The vehicle comes to a stop at the new target position 250 in the target area 251 so that the user 210 can get in. To determine the new target position 250, the driver assistance system 240 ascertains the current position 211 of the user 210 or driver depending on the radio signal, which can represent the position, or by means of vehicle sensors 201, 202. For example, the current position 211 of the user 210 can be ascertained by means of distance sensors 201 of the vehicle 200 and/or camera sensors 202 of the vehicle 200 and/or a system of the vehicle 200 for antenna-based localization, for example by means of UWB. The driver assistance system then calculates the new target position 250 on the stored trajectory 260 that is closest to the current position 211 of the driver. The distance between the new target position 250 and the current position 211 is therefore the distance 261 perpendicular to the stored trajectory 260, which passes through the new target position 250 and the current position 211 of the user. The target position 250 can then be adjusted to an adjusted target position 255 such that the shortest path 261 between the selected door of the vehicle and the driver's position is provided (not shown). The vehicle 200 then automatically moves along the stored trajectory 260 to the new target position 250, wherein it detects and avoids obstacles. The vehicle thus reaches the new target position 250 close to the driver, who can now get in comfortably.

What is claimed is:

1. A computer-implemented method for controlling a driver assistance system for a vehicle, wherein the driver assistance system provides a stored parking or positioning maneuver along a stored trajectory, the method comprising the following steps:
a) receiving a radio signal to activate traversal of the stored trajectory, wherein the radio signal is received from a smartphone or another mobile electronic device of a user;
b) determining a new target position of the vehicle based on an ascertained current position of the user, or the smartphone or the other mobile electronic device of the user, wherein the new target position is determined by a point on the stored trajectory that is closest to the ascertained position of the user, or the smartphone or the other mobile electronic device of the user; and
c) controlling the vehicle to traverse the stored trajectory to the determined new target position.

2. The method according to claim 1, wherein the received radio signal represents the current position of the smartphone or the electronic device of the user, the current position being ascertained using a global navigation satellite system.

3. The method according to claim 1, wherein the current position of the user or the smartphone or the other mobile electronic device of the user is determined: (i)using a sensor system of the vehicle for an antenna-based localization method and/or (ii) using an object detection and distance determination using at least one distance sensor and/or using at least one vehicle camera.

4. The method according to claim 1, wherein the new target position is adjusted such that a shortest path between: (i) a predetermined or user-selected door of the vehicle and (ii) the current position of the user or the smartphone or the other mobile electronic device of the user, is provided.

5. The method according to claim 1, wherein the stored trajectory is displayed on a display device of the vehicle and/or sent to the smartphone and/or the electronic device of the user, after activation of a function with the new target position by the user.

6. A driver assistance system for a vehicle, comprising:
a) a memory device configured to store a trajectory for a parking or positioning maneuver;
b) a communication device configured to receive a radio signal for activating a function for traversing the stored trajectory, the radio signal being received from a smartphone or another mobile electronic device of a user;
c) a computing unit configured to determine a new target position of the vehicle based on an ascertained current position of the user or the smartphone or the other mobile electronic device of the user, wherein the new target position is determined by a point on the stored trajectory that is closest to the current position of the user, or the smartphone or the other mobile electronic device of the user; and
d) a control unit configured to control a steering system and/or a drive system of the vehicle to traverse the stored trajectory to the new target position.

7. The driver assistance system according to claim 6, further comprising:
a sensor system for the antenna-based localization method and/or at least one distance sensor and/or at least one vehicle camera.

8. The driver assistance system according to claim 7, further comprising:
an object detection unit and/or a distance determination unit that ascertains the current position of the user based on sensor data of at least one vehicle sensor or the sensor system for the antenna-based localization method.

9. The driver assistance system according to claim 6, wherein the computing unit is configured to adapt the new target position so that a shortest path between: (i) a predetermined or user-selected door of the vehicle, and (ii) the current position of the user or the smartphone or the other mobile electronic device of the user, is provided.

10. A non-transitory computer-readable medium on which is stored program code for controlling a driver assistance system for a vehicle, wherein the driver assistance system provides a stored parking or positioning maneuver along a stored trajectory, the program code, when executed by a computing unit, causing the computer unit to perform the following steps:
a) receiving a radio signal to activate traversal of the stored trajectory, wherein the radio signal is received from a smartphone or another mobile electronic device of a user;
b) determining a new target position of the vehicle based on an ascertained current position of the user, or the smartphone or the other mobile electronic device of the user, wherein the new target position is determined by a point on the stored trajectory that is closest to the ascertained position of the user, or the smartphone or the other mobile electronic device of the user; and
c) controlling the vehicle to traverse the stored trajectory to the determined new target position.

11. The driver assistance system according to claim 6, wherein the vehicle maneuvers along the stored trajectory and, upon activation from outside the vehicle, moves to the new target position that is close to the current position of the user.

12. A vehicle, comprising:
a driver assistance system including:
a) a memory device configured to store a trajectory for a parking or positioning maneuver,
b) a communication device configured to receive a radio signal for activating a function for traversing the stored trajectory, the radio signal being received from a smartphone or another mobile electronic device of a user,
c) a computing unit configured to determine a new target position of the vehicle based on an ascertained current position of the user or the smartphone or the other mobile electronic device of the user, wherein the new target position is determined by a point on the stored trajectory that is closest to the current position of the user, or the smartphone or the other mobile electronic device of the user, and
d) a control unit configured to control a steering system and/or a drive system of the vehicle to traverse the stored trajectory to the new target position.
